(19) United States
(12) Patent Application Publication
(10) Pub. No.: US 2008/0300845 A1
(43) Pub. Date: Dec. 4, 2008

(54) Monitoring software simulations of hardware systems

(76) Inventors: Mark Kostick, Boston, MA (US); Dylan Dobbyn, Boston, MA (US); Joshua D. Marantz, Brookline, MA (US); Joseph C. Tatham, JR., Carlisle, MA (US); Jason P. Ansley, Burlington, MA (US); Matthew Grasse, Watertown, MA (US); William E. Neifert, Lexington, MA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 11/810,044

(22) Filed: Jun. 4, 2007

(51) Int. Cl. G06F 9/44

(52) U.S. Cl. 703/13

(57) ABSTRACT

System and methods for monitoring software simulations of hardware devices optimize the monitoring of a hardware system by comparing a current software state to previously stored patterns of software states in order to disable portions of the simulation.

### FIELD OF THE INVENTION

The present invention relates generally to hardware simulation and, more specifically, to high-speed, object-oriented hardware simulations.

### BACKGROUND OF THE INVENTION

Complex hardware devices often include components that remain dormant for long periods of time during execution of the device. For example a so-called “system-on-a-chip” may contain a processor and multiple peripheral components. While the system is booting, the peripherals may only be active while being configured by the processor, which is typically achieved via processor generated transactions that target the peripheral. While each transaction will cause the peripheral block to be active for a set period of time, it can remain dormant during the remaining cycles, which in some cases may represent a significant portion of the simulation. Conventional approaches for accelerating simulations of such hardware devices by disabling these models while they are inactive have shown some improvement in performance, but have significant drawbacks.

Parameterized execution, partially-monitored execution and fully-monitored execution are examples of such techniques. For example, parameterized execution provides a configurable number of cycles N for which the peripheral block is active—typically a worst-case number for each peripheral. But, because N must be established as a worst-case number, most transactions will result in wasted cycles.

Implementations of the partially-monitored execution approach incorporate some design knowledge into the simulation to determine when certain blocks can be disabled. Typically, this involves monitoring internal and/or external signals addressed to the block for particular signals and/or conditions. This approach may eliminate wasted cycles by executing the peripheral block only for the required number of cycles. Further, because the relevant signals of the device are monitored to determine when the transaction is complete, the worst-case value of N will be correct. This approach has a number of fundamental limitations, however. For example, intimate design knowledge is required to know which signals to monitor, causing the monitoring process to be error-prone and manual. Further, peripheral blocks containing multiple interfaces (such as an Ethernet interface controlling 10 ports with respect to an internal bus) can quickly generate extremely complex conditions which need to be monitored. As a result, the checker logic can sometimes require more execution overhead than the peripheral logic itself, thus eliminating any efficiencies gained by using this approach.

Fully-monitored execution expands upon the partially-monitored approach by monitoring every storage element and input pin to determine when components of the design are dormant. Benefits of this approach include the fact that no design knowledge is required, the worst-case conditions are automatically accounted for, and additional interfaces do not complicate the implementation because only state elements and pins are monitored. However, monitoring all of the state elements and pins in a design introduces significant execution overhead, and most designs are never totally dormant: there is almost always a state machine, counter or other logic that is changing state.

What is needed, therefore, is a technique for monitoring the execution of a hardware system that identifies dormant states of hardware peripherals in a manner that provides accurate simulation results while addressing the shortcomings described above.

### SUMMARY OF THE INVENTION

The present invention provides systems and methods for monitoring a software-based simulation of a hardware device in a manner that identifies opportunities to reduce processing overhead. For example, an execution monitor may be generated during compilation of a software object that simulates the hardware device. During execution of the simulation object, the monitor periodically (e.g., every clock phase) checks the states of internal storage elements, top-level interface pins and depositable nets, and can disable the execution of the model representing a particular component (or the entire device) when a dormant state is encountered.

Because the execution monitor can add processing overhead, a number of optimizations can be implemented to reduce the amount of required checking and/or to reduce the frequency with which the checks are performed. In addition, by recognizing that most design blocks create cyclic behavior even when dormant, the monitor can be configured to automatically recognize hardware cycles of arbitrary length.

Accordingly, in a first aspect, the invention provides a method for simulating the execution of an electronic device using, for example, a software object based on the design of the device; the design may, for example, take the form of a register transfer level (RTL) simulation. The method involves periodically saving state signature patterns (each a series of storage element states, pin states and/or combinational block states) of the device and/or components of the device during the execution of the simulation; this permits current state signatures to be compared to one or more of the previously saved state signatures. Upon recognition of a match between the current state signature and one of the saved signature patterns, the simulation is transitioned to an idle state, thus reducing execution overhead. Further, as subsequent state signatures are encountered, the simulation remains in the idle state so long as the subsequent state signatures continue to match one of the saved signatures.

The state signatures may be stored in a comparison buffer, which may be of arbitrary size, or specifically configured based on desired operational parameters such as speed and processing overhead. For example, in some embodiments, a specific, configurable number of state signature patterns is stored. In other implementations, the number of patterns may depend on the lengths of the patterns and the memory allocated to the buffer. In implementations in which the simulated device executes according to cycles corresponding to clock phases, the state signatures may be stored at each execution cycle. In some embodiments, the comparison may be halted after some number of cycles in which no match was found, in which case the simulation may transition to a backoff state during which no comparisons are made. In some instances, the comparisons may resume after some predetermined number of execution cycles without a comparison taking place. If a current state signature does not match any of the stored signatures, the current state signature may be stored for comparisons with subsequent state signatures.

In another aspect, the invention provides a system for simulating the execution of an electronic device. The system includes both storage and processing capabilities. The storage device stores state signature patterns encountered during the execution of a software object that simulates the electronic device. The processing device includes an execution monitor that compares a current state signature to previously stored state signature patterns, and transitions the simulation to an idle state upon recognition of a match between the current state signature and one of the saved state signatures. Further, the execution monitor determines state signatures for subsequent execution cycles and maintains the idle state so long as the subsequent state signatures continue to match a stored state signature pattern.

In another aspect, the invention provides software in computer-readable form for performing the methods described herein.

The foregoing and other objects, features and advantages of the present invention disclosed herein, as well as the invention itself, will be more fully understood from the following description of preferred embodiments and claims, when read together with the accompanying drawings.

### BRIEF DESCRIPTION OF THE DRAWINGS

In the drawings, like reference characters generally refer to the same features or steps throughout the different views. The drawings are not necessarily to scale, emphasis instead generally being placed upon illustrating the principles of the invention. In the following description, various embodiments of the invention are described with reference to the following drawings, in which:
FIG. 1 is a block diagram of a system for simulating the execution of a hardware device in accordance with one embodiment of the invention.
FIG. 2 is a flowchart depicting a method for simulating the execution of a hardware device in accordance with an embodiment of the invention.
FIG. 3 is another flowchart depicting a method for simulating the execution of a hardware device in accordance with an embodiment of the invention.
FIG. 4 is an illustration of a series of stored system states used for comparison in accordance with an embodiment of the invention.
FIG. 5 also illustrates a series of stored system states used for comparison in accordance with an embodiment of the invention.
FIG. 6 is a block diagram of a general-purpose computer on which embodiments of the invention may be implemented.

### DETAILED DESCRIPTION

The present invention facilitates the simulation and analysis of software objects that represent coded descriptions of electronic devices (e.g., a Verilog RTL description). The electronic device may be an electronic chip, a small functional block of a chip, numerous chips which make up a complete system, or any other combination of electronic components. The software object may, for example, be used to simulate the electronic device in order to facilitate development and testing of software that will be used therewith prior to device availability. Use of such a simulation can permit software development to proceed in parallel with hardware development, reducing overall time to market.

The following terms and corresponding definitions are used herein. A pin means a physical pin of a hardware device that represents an input, output or in-out element. A storage element refers to any element that retains a logical value, even in instances in which certain non-clock inputs change. In a physical hardware device, examples of storage elements include latches and flip-flops. A combinational block may be any logical element whose value is immediately dependent upon the value of its inputs, such as AND gates and OR gates. A net means a wire in physical hardware that interconnects two or more storage elements, combinational blocks and/or pins. A deposit is a method by which the value of a pin, net or storage element is changed. A depositable net is a net in the design that may be modified by external stimuli. A monitored element may refer to a pin, storage element or combinational block that is actively monitored for change, and an ineligible net is a net whose deposits are not tracked by the execution monitor.

Referring to FIG. 1, when designing a hardware device 105, it is common for hardware designers to first describe the device 105 in terms of a hardware-description language, e.g., as a Verilog register-transfer level (RTL) file 110 (it being understood that the invention is compatible with essentially any hardware description or hardware-description language). The electronic device 105 may be, for example, an electronic chip, a small functional block of a chip, numerous chips that make up a complete system, or any other combination of electronic components. The RTL description 1 10 represents a complete functional characterization of the device 105, specifying the registers of the device and the manner in which data is transferred among them; this representation is preferable, for performance purposes, to a lower-level (e.g., gate level) description. Interconnections within the hardware may be represented as vectors, rather than requiring each wire of, for example, a wide bus to be defined explicitly. In any case, the description contains sufficient detail to permit a software simulation of the system to be generated, and the description is processed by a compiler into a software simulation object 115. This object may be used to simulate the operation of the actual device 105 in order, for example, to facilitate development and testing of software that will be used with the device before it is physically available.

For example, suppose the hardware 105 being simulated is a network interface designed for use on a computer that supports a PCI bus interface, a USB port interface, and a PCMCIA interface. In this case, the simulation object 115 will simulate the functionality of all of these interfaces, and may be used in conjunction with, for example, diagnostic software designed to test the chip. Running the simulation involves applying to the object 115 software representations of the data signals that would be applied to the terminals of the physical device. The software object, in turn, not only responds with data representative of the output signals that the device would generate, but also maintains an internal representation of the register operations underlying the device output. These may be analyzed to investigate device behavior and identify potential design problems.

Software programs written for the device may not interact directly with the simulation object, but instead through an application programming interface (API) 125 that mediates activities and data flow between the internal object representation of the device 105 and an external program designed for interaction with an actual hardware device (not shown). The API 125 thereby provides an abstraction layer, translating the functionality into inputs, outputs, and clock cycles that are handled by the simulation object 115. For example, the simulation object 115 may operate cycle by cycle, whereas functions provided through the API 125 may involve multiple cycles.

When executing the software object 115, however, it is often necessary to re-execute the same or similar simulations multiple times to better understand and resolve design defects. Because software objects that represent complex electronic devices are themselves complex and may require a long time to execute, re-execution can become quite time-consuming. Much of this time is wasted when the system being simulated comprises multiple devices (e.g., peripherals such as printers, keyboards, network interfaces, media cards, displays, and the like) which may remain dormant during much of the simulation. For example, once a peripheral is configured during a boot process, it may not interact with other components of the system. Simulating the processing interactions of these peripherals during these idle states adds unnecessary overhead to the simulation process.

In accordance with the present invention, these “dormant states” are identified based on recognized state patterns. In one embodiment, for example, an execution monitor is generated (as part of the software compile process, for example) that checks the states of all the internal storage elements, top-level interface pins and/or depositable nets in a model representing a particular component or components, and selectively disables the simulation of a component when it enters a dormant state.

In some embodiments, a comparison buffer is used in conjunction with the execution monitor to recognize cyclic behavior of the various system states. For example, the comparison buffer can include pointers, e.g., an insertion pointer for storing the location in the buffer where the next state will be saved, and a comparison pointer that indicates which saved eligible state will be compared against the current state. In addition, cycle-begin and cycle-end pointers may be maintained to allow for state patterns of arbitrary and/or changing length.

In brief overview, FIG. 2 depicts one example of a method for modifying the execution processes of a software object simulating a hardware device by identifying and exploiting cyclical state patterns, thereby reducing processing overhead. During the simulation, the execution monitor operates in one of three possible states: a “looking” state 205 during which the system is actively executing and producing outputs based on system stimuli and comparing the outputs to identify matches to previously stored state patterns; an “idle” state 210 during which only input stimuli are compared across execution cycles and the system is not executing; and a “backoff” state 215 during which the system is fully executing and no comparisons are taking place.

Initially, execution of the software object is in the looking state, during which the design is actively monitored to identify a repeating pattern and the RTL functionality of the device is fully simulated. Monitoring may include, for example, looking at all of the state elements and deposits. In some instances, certain deposits may be directed to ineligible nets (generally any net in the design which does not feed into a clock net) (STEP 220), in which case the monitor discards the comparison data from the comparison buffer and switches to backoff mode 215. In some implementations, a maximum number of comparisons may be set to allow the execution monitor to halt, if, for example, no recognized pattern has been identified after some number of cycles. The number of cycles may be configured according to user-specific needs. In practice, a smaller number of stored patterns results in fewer comparisons prior to finding a match or storing the new pattern for subsequent comparisons, whereas storing a larger number of stored patterns increases the chance of finding a match and entering the idle state (at the price more searching and comparison overhead).

The current state is then compared to the stored state patterns in the comparison buffer to determine if there is a match (STEP 230). If the current state pattern matches a previously stored pattern (or some portion thereof), the monitor assumes that it has found a cyclic condition and transfers from the looking state to the idle state 210. If there is no match, the state may be stored for future comparison. In some implementations, the comparison buffer is configured to store a maximum number of state patterns. In such cases, a determination is made as to whether the maximum buffer size has been reached (STEP 235), and if so, the system enters the backup state. If not, the system remains in the looking state, continuing to monitor the system for state patterns. When the system is in the backoff state 215, all pointers are reset and RTL behavior is executed without any state comparison. In some cases, a backoff counter may be used to track the number of cycles having executed without performing a comparison, in which case each execution cycle causes the backoff counter to be incremented. When the backoff counter reaches a predefined number (e.g., 0 if incrementing down from an initial counter value), the system transitions back to the looking state and automatically begins remonitoring the module.

Referring to FIG. 3, the processes of maintaining the system in the idle state 210 and transitioning from the idle state to the backoff state are illustrated in greater detail. While in the idle state 210, and at each execution cycle, a determination is made if the deposit is being made to an eligible net (STEP 305). If not, the system transfers from the idle state to the backoff state, and the insertion and comparison pointers are reset. If the deposit is being made to an eligible net, the values of all the storage elements are assembled (STEP 315) and compared to the stored states (STEP 320) in the comparison buffer. If a match is found, the system remains in the idle state and continues to monitor deposits (STEP 305) and the comparison pointer is incremented. If no match is found, a determination is made as to whether the maximum number of states that can be stored in the buffer has been reached (STEP 325). If so, the system transitions to the backoff state 310. However, if space remains in the buffer, the current state may be added to the comparison buffer for subsequent comparisons, the system transitions to the looking state, and the next deposit is compared to the state patterns in the buffer.

While in the idle state, the system no longer monitors the state of all the storage elements in the design and the RTL behavior of the module may be totally disabled. Instead, only the deposits to the module are monitored, and any deposit to an ineligible net will cause the RTL state to be restored using the most recent matching stored state pattern, and the monitor transitions to the backoff state. If the comparison pointer is incremented beyond the end of the cycle (as indicated by the cycle end pointer) it is reset to the location indicated by the cycle begin pointer.

FIG. 4 provides an example using system timestamps (numbers) and the state signatures corresponding to the timestamps (letters). At the first three timestamps 405, the monitor is operating in the looking state as there have been no repeated patterns. At timestamp 3, however, the first state in state signature 405′ matches timestamp 0, so the monitor transitions to the idle state, the cycle-begin pointer is set to 0, and the cycle-end pointer is set to 2. While in the idle state, the following two signatures (B and C) follow the expected pattern and the comparison pointer is incremented accordingly. If the size of the comparison buffer has not yet been reached, subsequent matching signatures (B and C in this case) may be stored in the buffer in case a larger cycle is detected.

At timestamp 6, a mismatch is detected between the current state pattern 405 and the current input 410, so the monitor transitions to the looking state and the simulation image is restored. In one embodiment, the design state is stored after each execution cycle while the execution monitor looks for a pattern. When a pattern is found, the saved states may be retained and reloaded from the previous pointer in the pattern. Once in the looking state, the simulation behavior for timestamp 6 is executed. At timestamp 7 the signature 410 is compared with state signatures 405 and 410 (either individually or as a series) in the comparison buffer. A match is found at timestamp 6, so the comparison pointers are set to timestamp 6 and the monitor transitions to the idle state. The next two signatures match the state pattern found at the comparison pointer, so the design remains in the idle state. Once again, if there is room in the comparison buffer, each signature may be stored. At timestamp 9, the signature does not match the signature pointed to by the comparison pointer, so the RTL state for timestamp 8 is loaded, the RTL behavior is simulated, and the monitor transitions to the looking state. A comparison to the state patterns in the comparison buffer finds a match at timestamp 0, thus causing the cycle-begin pointer to point to timestamp 0 and the cycle-end pointer to be set to 8, as it is the most recent timestamp not matching any part of the detected cycle. The entire cycle then repeats. If there is room in the comparison buffer, it may again be stored in case a larger cycle is detected. If there is no room, additional state patterns may be discarded while still cycling through the detected cycle, or in some cases the oldest state pattern may be discarded and replaced with the most recent pattern.

FIG. 5 illustrates the behavior of the system when it is not cyclic enough to enable the design to remain in the idle state. In this example, the design transitions from the looking state into the idle state a few times when a state signature matches a previously stored signature, but because there are no cyclical states (e.g., patterns of multiple states), the comparison buffer fills up, the monitor transitions to the backoff state and the comparison buffer is cleared.

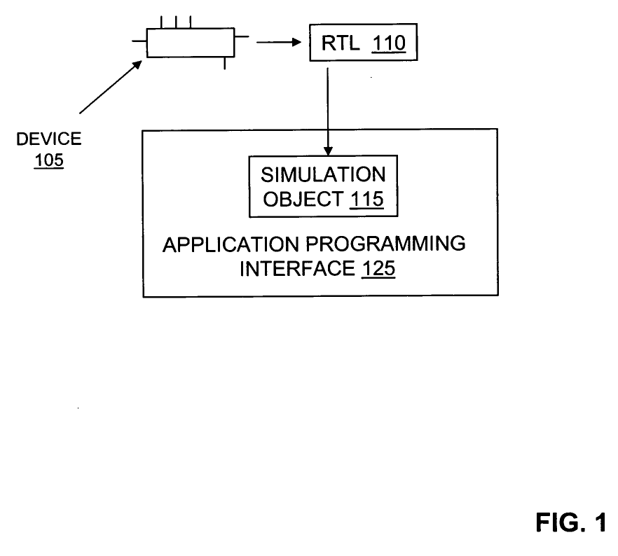

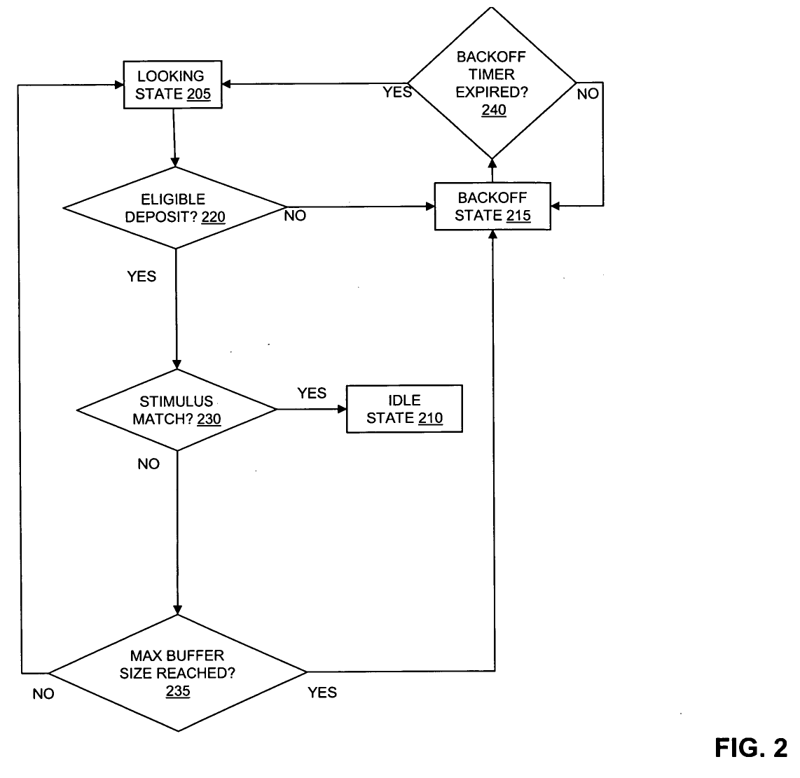

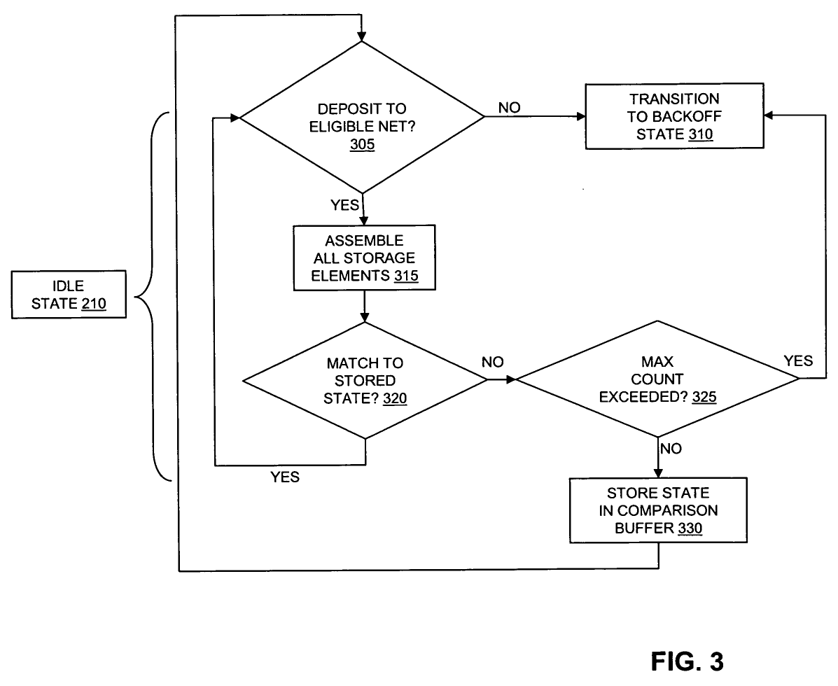

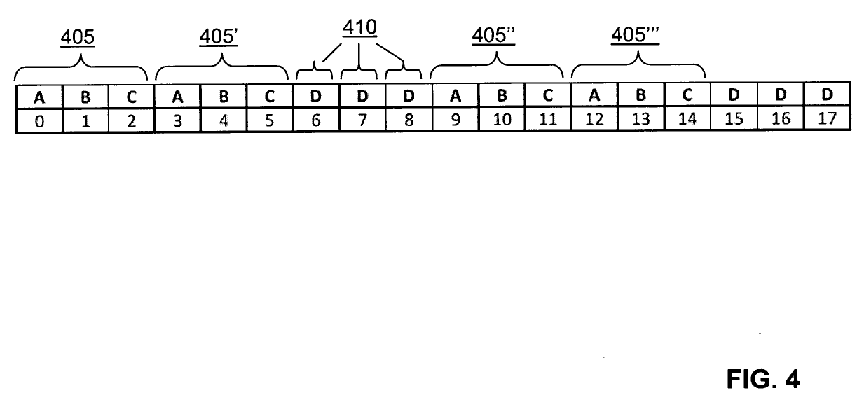

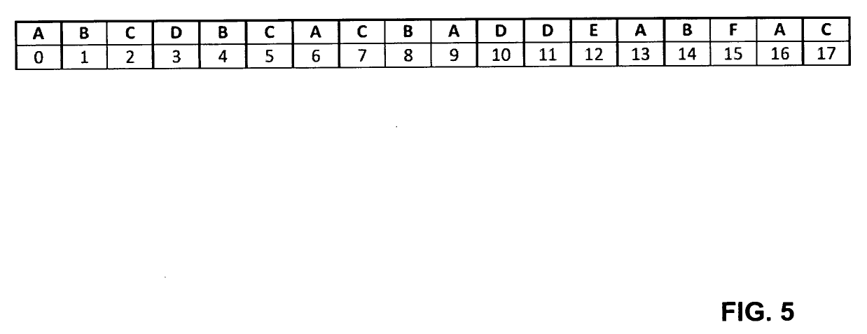

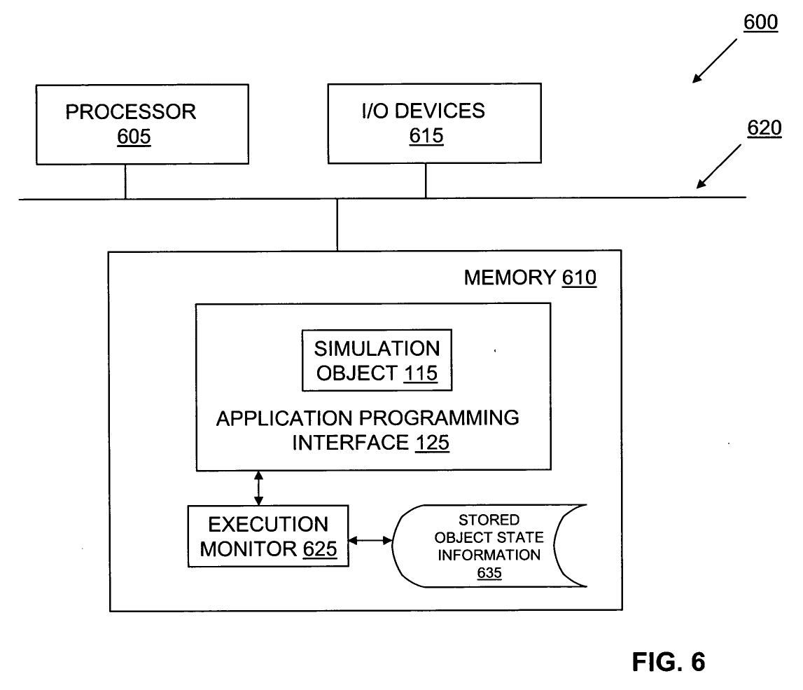

The functionality of the systems and methods described above may be implemented as software on a general purpose computer, such as a general purpose computer 600, as shown in FIG. 6. The general purpose computer 600 includes a processor 605, a memory 610, and I/O devices 615. The processor 605, the memory 610, and the I/O devices 615 are interconnected by a bus 620.

The processor 605 executes instructions that cause an execution monitor 625 to perform the functions dictated by the instructions. These instructions are typically read from the memory 610. In some embodiments, the processor 505 may be a microprocessor, such as an Intel 80×86 microprocessor, a PowerPC microprocessor, or other suitable microprocessor.

The I/O (input/output) devices 615 may include a variety of input and output devices, such as a graphical display, a keyboard, a mouse, a printer, magnetic and optical disk drives, network interface, or any other input or output device that may by connected to a computer. The I/O devices 615 may permit instructions and data to be transferred from various computer readable media, such as floppy disks, hard disks, or optical disks into the memory 610.

The memory 610 may be random access memory (RAM), read-only memory (ROM), flash memory, or other types of memory, or any combination of various types of memory (e.g., the memory 610 may include both ROM and RAM). The memory 610 stores instructions which may be executed by the processor 605, as well as data that may be used during the execution of such instructions. In particular, the application programming interface 125 and the execution monitor 625 are conceptually illustrated as modules stored for execution in memory 610. These modules may be straightforwardly realized in accordance with the descriptions of their functionality, as described above. Memory 610 also contains the stored object state information 635 upon which the execution monitor 625 operates.

The software implementing these modules may be written in any one of a number of high-level languages, such as C, C++, C#, LISP, or Java. Further, portions of the software may be written as script, macro, or functionality embedded in commercially or freely available software. Additionally, the software could be implemented in an assembly language directed to a microprocessor used in the general purpose computer 700, such as an Intel 80×86, Sun SPARC, or PowerPC microprocessor. The software may be embedded on an article of manufacture including, but not limited to, a “computer-readable medium” such as a floppy disk, a hard disk, an optical disk, a magnetic tape, a PROM, an EPROM, or CD-ROM.

It will be understood that the general purpose computer 600 is for illustrative purposes only, and that there are many alternative designs of general purpose computers on which software implementing the methods of the invention can be used.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method of simulating execution of an electronic device, the method comprising:
periodically saving state signature patterns during execution of a simulation of the device, each of the saved state signature patterns including a first state signature;
in a current execution cycle, comparing a current state signature to the first state signature in at least one of the saved state signature patterns;
upon recognition of a match between the current state signature and the first state signature in one of the saved state signature patterns, transitioning the simulation to an idle state;
determining state signatures for subsequent execution cycles; and
maintaining the simulation in the idle state for subsequent execution cycles so long as the subsequent state signatures continue to match the one of the state signature patterns.

2. The method of claim 1 wherein the state signature patterns comprise one or more states selected from storage element states, states or combinational block states.

3. The method of claim 1 wherein the state signature patterns are stored to a comparison buffer.

4. The method of claim 3 wherein a maximum of N state signature patterns are stored in the comparison buffer, where N is an integer greater than 1.

5. The method of claim 4 wherein N is configurable.

6. The method of claim 1 wherein the electronic device executes according to execution cycles corresponding to a clock phase, and the state signature patterns are stored at each execution cycle.

7. The method of claim 6 further comprising halting the comparison after executing for a maximum number of cycles without having identified a match and transitioning to a backoff state.

8. The method of claim 7 further comprising restarting the comparison after a predetermined number of execution cycles during which no comparison was made.

9. The method of claim 1 wherein the simulation comprises a register transfer level simulation of the electronic device.

10. The method of claim 1 further comprising, upon determination that the current state signature does not match any of the saved state signature patterns, saving the current state signature for subsequent comparisons.

11. A computer program product embodied on a computer-readable medium and comprising computer code comprising instructions for:
executing a simulation of an electronic device;
periodically saving state signature patterns during execution of the simulation, each of the saved state signature patterns including a first state signature;
in a current execution cycle, comparing a current state signature to the first state signature in at least one of the saved state signature patterns;
upon recognition of a match between the current state signature and the first state signature in one of the saved state signature patterns, transitioning the simulation to an idle state;
determining state signatures for subsequent execution cycles; and
maintaining the simulation in the idle state for subsequent execution cycles so long as the subsequent state signatures continue to match the one of the state signature patterns.

12. The computer program product of claim 11 further comprising instructions for saving the state signature patterns to a comparison buffer.

13. The computer program product of claim 11 wherein a maximum of N state signature patterns are stored in the comparison buffer, and further comprising instructions for setting N to an integer greater than 1.

14. The computer program product of claim 11 wherein the electronic device executes according to execution cycles corresponding to a clock phase, and further comprising instructions for storing the state signature patterns at each execution cycle.

15. The computer program product of claim 14 further comprising instructions for halting the comparison after executing for a maximum number of cycles without having identified a match and transitioning to a backoff state.

16. The computer program product of claim 15 further comprising instructions for restarting the comparison step after a predetermined number of execution cycles during which no comparison was made.

17. The computer program product of claim 11 further comprising instructions for saving the current state signature for subsequent comparisons upon determination that the current state signature does not match any of the saved state signature patterns.

18. A system for simulating execution of an electronic device, the system comprising:
a storage device for storing saving state signature patterns during execution of a simulation of the electronic device; and
a monitoring module for:
(i) comparing a current state signature to the first state signature in at least one of the saved state signature patterns;
(ii) transitioning the simulation to an idle state upon recognition of a match between the current state signature and the first state signature in one of the saved state signature patterns;
(iii) determining state signatures for subsequent execution cycles; and
(iv) maintaining the simulation in the idle state for subsequent execution cycles so long as the subsequent state signatures continue to match the one of the state signature patterns.
